(19) United States
(12) Patent Application Publication
(10) Pub. No.: US 2025/0172495 A1
(43) Pub. Date: May 29, 2025

(54) METHOD FOR DETERMINING A SCATTERED LIGHT PARAMETER AND MEASURING ARRANGEMENT FOR PERFORMING THE METHOD

(71) Applicant: Endress+Hauser Conducta GmbH+Co. KG, Gerlingen (DE)

(72) Inventors: Matthias Grossmann, Vaihingen-Enz (DE); Andreas Bayer, Gerlingen (DE); Thilo Krätschmer, Gerlingen (DE)

(21) Appl. No.: 18/960,481

(22) Filed: Nov. 26, 2024

(30) Foreign Application Priority Data
Nov. 27, 2023 (DE) 10 2023 133 012.8

(51) Int. Cl. G01N 21/51

(52) U.S. Cl. CPC G01N 21/51; G01N 2021/516; G01N 2201/0218

(57) ABSTRACT

A method for determining a scattered light parameter, for example turbidity, in a medium using a measuring arrangement, the method including the steps of: transmitting excitation light into the medium, wherein the excitation light is scattered in the medium; receiving the light scattered in the medium; transmitting excitation light into the medium towards the medium surface, wherein the excitation light is reflected at the medium surface; receiving the light reflected from the medium surface; and determining the scattered light parameter, in particular turbidity, from the scattered light and reflected light. The present disclosure further discloses a measuring arrangement for performing the method.

### CROSS-REFERENCE TO RELATED APPLICATION

The present application is related to and claims the priority benefit of German Patent Application No. 10 2023 133 012.8, filed on Nov. 27, 2023, the entire contents of which are incorporated herein by reference.

### TECHNICAL FIELD

The present disclosure relates to a method for determining a scattered light parameter, for example turbidity, and a measuring arrangement for performing the method.

### BACKGROUND

In the following, the problem to be solved is described by way of example on the basis of a turbidity measurement. The ISO 7027 standard, which is relevant for turbidity measurements in liquids, prescribes scattered light measurement at an angle of 90° for the measurement of low turbidity. Optical sensors for measuring the turbidity of a liquid which meet this standard have the disadvantage that the signal curve is not unambiguous in all media—as the turbidity of the liquid increases, the scattered light signal initially increases up to a maximum value. However, once this limit is exceeded, the signal decreases again despite increasing turbidity, since less and less scattered light reaches the sensor's detector due to multiple scattering.

Due to the ambiguous signals, the measurement cannot distinguish between very low and very high turbidity values and thus the turbidity value or the solids content of a liquid cannot be clearly determined. For example, a black medium that is heavily contaminated with particles is incorrectly interpreted as clean, clear liquid.

Since international regulations and legal requirements often require turbidity measurement according to ISO 7027 and thus only a single scattered light signal with a 90° angle can be used, additional measuring devices usually have to be installed in order to obtain further information about the actual turbidity value or solids content of the medium via additional measured variables. This entails considerable additional costs and installation effort for the operators.

### SUMMARY

The present disclosure is based on the object of performing optical scattered light measurements with only one measuring channel (for example at 90° according to ISO7027) in such a way that a clear distinction can be made between a medium with low turbidity (e.g. clear water) and a liquid with very high turbidity (e.g. black wastewater with a high particle content) or the turbidity value and/or the solids content of the liquid can be detected.

The object is achieved by a method for determining a scattered light parameter, in particular turbidity, in a medium by means of a measuring arrangement, for example including a turbidity sensor. Specifically, the method comprises the following steps:
a) transmitting excitation light into the medium, wherein the excitation light is scattered in the medium;
b) receiving the light scattered in the medium;
c) transmitting excitation light into the medium towards the medium surface, wherein the excitation light is reflected at the medium surface;
d) receiving the light reflected at the medium surface; and
e) determining the scattered light parameter, in particular turbidity, from the scattered light and reflected light.

With the solution according to the present disclosure, the clear distinction between a medium with low turbidity and a liquid with very high turbidity or absorption is achieved in that the transmitted light of the sensor is reflected, temporarily or permanently, at the surface of the medium and the signal strength of this reflected light is evaluated. While reflection in a clear medium leads to a strong measurement signal, since the reflection hits the detector with full intensity without attenuation, the reflected signal is attenuated in a strongly absorbing and/or strongly scattering medium, which results in significantly lower measurement values.

This results in a clear detection of the turbidity or the solids content of a medium despite measurement according to ISO 7027 with only one scattered light signal. This also results in high economic efficiency by saving on additional measuring devices (cost savings, lower installation and service costs). The measuring range can also be extended. A further advantage is that it is easier for the user to select the correct model for calculating turbidity from the scattered light intensities.

At least one embodiment provides that the relative distance between the measuring arrangement and the medium surface is changed between the above-mentioned steps b) and c).

At least one embodiment provides that the measuring arrangement is moved towards the medium surface, for example via a rotational or translational movement.

At least one embodiment provides that the medium surface is lowered or raised.

At least one embodiment provides that the incidence angle of the excitation light into the medium is designed in such a way that total reflection occurs at the medium surface.

At least one embodiment provides that the above-mentioned steps c) and d) are performed less frequently than steps a) and b).

The object is further achieved by a measuring arrangement, for example a turbidity sensor, for performing the method described above, comprising at least one light source that transmits excitation light into the medium and towards the medium surface; at least one photodiode that receives light scattered in the medium and light reflected at the medium surface and converts it into an electrical signal; and a data processing unit that determines the scattered light parameter, for example turbidity, from the electrical signal.

At least one embodiment provides that the measuring arrangement comprises one or more floating bodies that hold the measuring arrangement at a defined but variable distance from the medium surface, wherein the floating body is arranged outside the measuring arrangement.

At least one embodiment provides that the measuring arrangement comprises at least one buoyancy chamber that holds the measuring arrangement at a defined but variable distance from the medium surface, wherein the buoyancy chamber is arranged in the measuring arrangement.

At least one embodiment provides that the measuring arrangement comprises a basin with an inflow and an outflow for the medium, wherein the light source and the photodiode are arranged in the basin or outside the basin.

At least one embodiment provides that the measuring arrangement comprises a basin with at least one inflow and a plurality of outflows for the medium, wherein the light source and the photodiode are arranged in the basin or outside the basin.

### BRIEF DESCRIPTION OF THE DRAWINGS

The present disclosure is explained in more detail with reference to the following figures.

FIG. 1 shows an arrangement for measuring scattered light with an optical path in general.

FIGS. 2a and 2b show the measured scattered light intensity at different turbidities according to the prior art (2a) and by means of the claimed measuring arrangement or method (2b).

FIGS. 3a-3d show the reflection at the medium surface in a less turbid medium (3b, 3d) and more turbid medium (3a, 3c), wherein the arrangement is arranged further away (3a, 3b) or closer (3c, 3d) to the medium surface.

FIGS. 4a-4d show the reflection at the medium surface in a less turbid medium (4b, 4d) and more turbid medium (4a, 4c), wherein the arrangement is arranged further away (4a, 4b) or closer (4c, 4d) to the medium surface.

FIGS. 5a and 5b symbolically show the movement of the sensor or a change in the medium surface.

FIGS. 6a-6c show embodiments for varying the distance of the arrangement to the medium surface.

FIG. 7 shows the claimed measurement arrangement in one embodiment.

FIG. 8 shows the claimed measurement arrangement in one embodiment.

FIG. 9 shows the claimed measurement arrangement in one embodiment.

In the figures, the same features are labeled with the same reference signs.

### DETAILED DESCRIPTION

Any light striking particles suspended in a liquid is scattered. The intensity of this light scattering is used in optical turbidity measurement as a direct measure for the determination of turbidity. Different measurement angles are used for different applications—in part due to national legal provisions. For example, the 90° scattered light is used in drinking water applications, among others. Breweries often use a scattered light angle in the range of 11° to 25°. In measurements in sludges, a backscattering angle of >90° (e.g., 135°) is mostly used. “FNU” units (Formazin Nephelometric Units) are often used as reference measurement or for turbidity values.

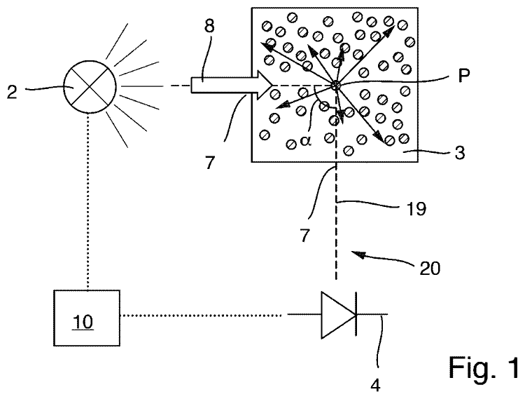

Typically, a turbidity sensor based on scattered light measurement can be represented symbolically as shown in FIG. 1. From the light source 2, excitation light 8 (see broad arrow) is radiated into a measuring chamber through a window 7 that is transparent to the excitation light 8. There, the light is scattered by particles in the medium 3 to be measured at an exemplary scattering point P under a measuring angle α (here 90° as an example) and converted into “scattered light 19” (dashed vertical line). In reality, the scattering is not a single line (ray of light) as shown but a blurred volume. Likewise, the scattering does not occur at a single point P, but at all particles in the medium 3

The light reaches a receiver 4 via a window 7 that is transparent to the scattered light 6 (only a single window can be used), for example via one or more apertures or lenses. The light intensity arriving at the receiver 4 is a measure of the turbidity. The light path from the light source 2, through a window 7 into the medium 3, to the scattering point P, through the medium 3 and through a window 7 to the receiver 4 is generally referred to as “optical path 20” (dashed line). As mentioned above, scattering in reality does not result in just a single line (ray of light), but rather a blurred volume. The “optical path 20” thus encompasses the entirety of this blurred volume.

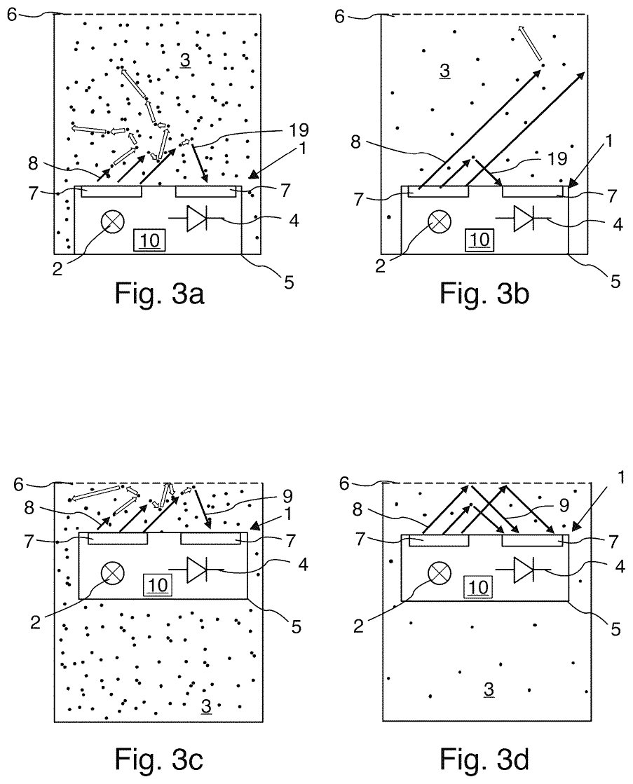

The claimed measuring arrangement 1 (see FIGS. 3-9) is also referred to below as a sensor or turbidity sensor. The turbidity sensor 1 is arranged on a container, for example on a pipe or in a basin or open channel. This is carried out via fastening means, such as a flange. The turbidity sensor can also be arranged on an immersion or quick-change fitting or the like. The medium to be measured 3 is located in the container, or the medium 3 may flow through the container. The medium 3 to be measured is mostly a liquid-often process and waste water. The arrangement is, however, also used in fresh water, for example, drinking water. When used on a container, the turbidity sensor is arranged substantially perpendicular to the longitudinal axis of the container, such as the pipe. The turbidity sensor comprises a housing 5. Stainless steel, plastic, or a ceramic may be used as materials for the arrangement 1, for example for the housing 5. The materials are selected to ensure that they are suitable for the respective application.

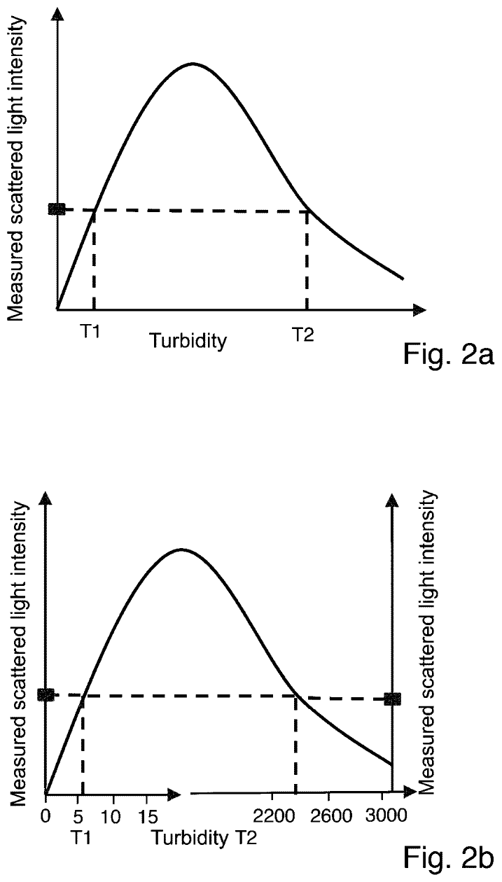

The arrangement 1 comprises at least one light source 2 and a receiver 4. The light source and the receiver are connected to a data processing unit 10 (such as a microcontroller) via electrical connections (see the dotted line in FIG. 1). The data processing unit 10 determines the measured variable to be determined, e.g. the turbidity, from the electrical signal of the scattered light. The determination this measured variable is effected by means of a calibration model, which combines the measured information regarding the received scattered light intensities and uses this to ascertain the turbidity. FIGS. 2a and 2b, for example, show the relationship between measured scattered light intensities and the corresponding turbidity.

The receiver 4 is, for example, designed as a photodiode, which generates a receiver signal, such as a photocurrent or a photovoltage (generally an electrical signal), from the light received.

The light source 2, for example an LED, transmits light towards the medium 3. In this respect, “light”, within the meaning of this application, is not to be limited to the visible range of the electromagnetic spectrum, but is to be understood as electromagnetic radiation of any wavelength, in particular even in the ultraviolet (UV) and in the infrared (IR) wavelength ranges. For example, a wavelength of the light may be 860 nm. The arrangement can comprise other optical components in the beam path after the light source, such as filters or one or more lenses (not shown). Corresponding components are also arranged on the receiver side, at the photodiode 4.

In FIG. 2a, the measured scattered light intensity is the same for two different turbidity values, so it is not possible to distinguish between turbid and clear water from a purely measurement point of view (prior art).

With the claimed measuring arrangement 1 and the corresponding method, the clear distinction between a medium 3 with low turbidity and a medium with very high turbidity or absorption is achieved in that the transmitted light 8 of the sensor 1 is temporarily reflected on the surface 6 of the medium 3 and the signal strength of this reflected light 9 is evaluated. While the reflection in a clear medium leads to a strong measurement signal, since the reflection is incident on the detector 4 with full intensity without major attenuation, the reflected signal is strongly attenuated in an absorbing and/or scattering medium, which results in significantly lower measurement values.

Since the claimed solution eliminates the ambiguity of the signal curve, the measuring range of the sensor 1 can be significantly increased, since even high turbidities on the falling part of the signal curve can be measured. While with turbidity sensors under the prior art only the measured values of one side of the curve can be used, both sides of the curve can be used due to the clear assignment of the measured scattered light intensity to one of the two sides of the signal curve. This results in a significantly larger measuring range, on the one hand, and, on the other hand, the assignment of a measured scattered light intensity to an incorrect turbidity value is avoided. FIG. 2b shows that both the left-hand and right-hand halves of the scattered “light intensity-turbidity curve” can be used. In this way, a separate calibration curve can be assigned to both the right-hand and left-hand sides of the curve, which assigns a unique turbidity measurement value to the measured scattered light intensity as a function of the known side of the curve. While media with low turbidity are evaluated using the left-hand side of the curve, media with high turbidity values can be detected with the aid of the right-hand side of the curve.

In addition, the uniqueness of the signal curve simplifies model selection for the user. A model that is, for example, optimized for the measurement of clear media (e.g. drinking water) can be excluded in advance or actively blocked by the software of sensor 1, if the sensor detects a liquid with very high turbidity or absorption (e.g. contaminated, black wastewater with a high particle content).

In order to realize the reflection at the medium surface, the sensor 1 must be positioned at least temporarily such that its beam path is directed from below against the surface 6 of the medium.

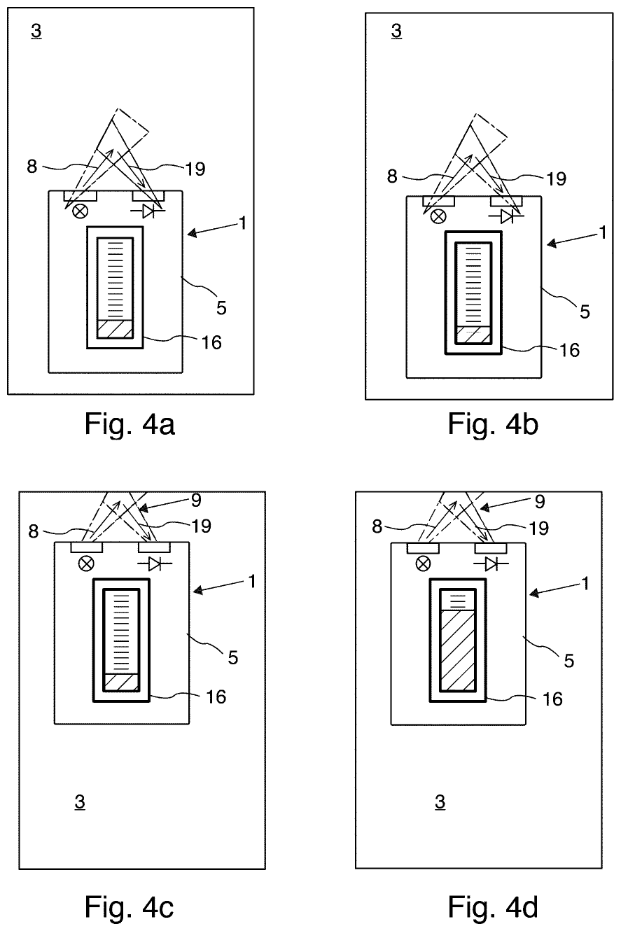

FIG. 3 shows the measuring arrangement 1 in a less turbid medium (FIGS. 3b, 3d) and in more turbid medium (FIGS. 3a, 3c). The measuring arrangement 1 can be arranged further away from the medium surface 6 (FIGS. 3a, 3b) or closer to it (FIGS. 3c, 3d). This is also shown analogously in FIGS. 4a-4d in a different representation. The scale 16 shows the measured light intensity at the detector 4. The scattered light cone is also shown in FIGS. 4a-4c.

The light source 4 emits the excitation light 8 into the medium 3 to be measured, for example into water, wherein the excitation light 8 is scattered in the medium. The scattered light 9 is received by a photodiode 4 and converted into an electrical signal. It can be symbolically seen in FIGS. 3a, 3c and FIGS. 4a, 4c that relatively high scattering occurs in turbid media with a large number of particles. In less turbid media, see FIGS. 3b, 3c and FIGS. 4b, 4c, less scattering occurs.

In addition to the scattering in the medium 3, the transmitted light 8 is reflected at the medium surface 6. If the measuring arrangement 1 is arranged closer to the medium surface 6, more light can be reflected, see FIGS. 3c, 3d and FIGS. 4c, 4d. The scattered light 9 is received by the photodiode 4 and converted into an electrical signal.

As a function of the distance of the measuring arrangement 1 to the surface 6, more reflection or scattering occurs.

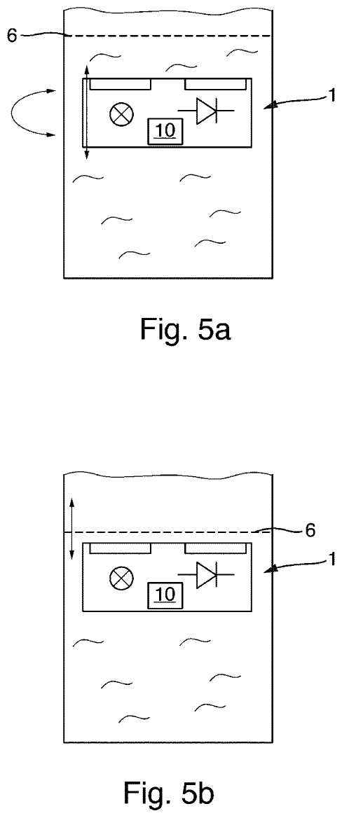

The temporary reflection can then be achieved by either moving the sensor 1 as a movable measuring device towards the surface 6 (see FIG. 5a; symbolized by the vertical arrow above the measuring arrangement 1) or by installing the sensor 1 in a fixed position and lowering or raising the liquid level (FIG. 5b; symbolized by the vertical arrow above the surface 6). In addition to a translational movement, a rotational movement is also possible (this is symbolized by the semicircular arrow in FIG. 5a; or a combination of rotational and translational movements).

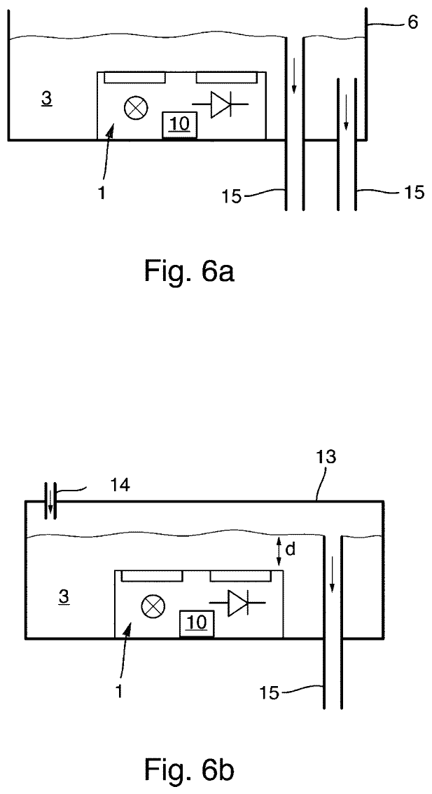

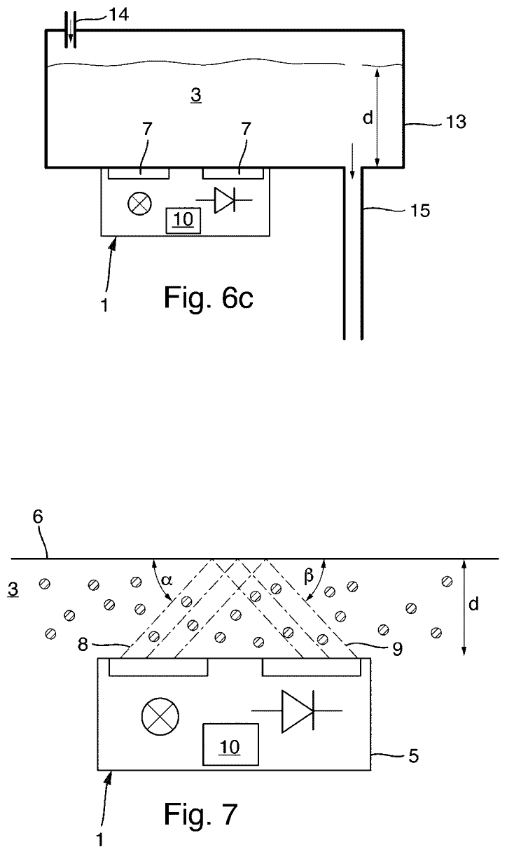

The raising or lowering of the liquid level can be achieved, for example, by arranging different outlets 15 at different heights in a basin, a fitting or a channel, which outlets are opened or closed to change the level. This is shown in FIG. 6a. For automating this process, the outlets can be automatically controlled via solenoid valves and a higher-level control system.

FIGS. 6b and 6c show an embodiment with a basin 13 with an inflow 14 and an outflow 15 for the medium 3. Here as well, the arrangement measures from bottom to top towards the medium surface 6. The distance d between the arrangement 1 and the surface can be adjusted by means of the inflow 14 when the discharge 15 is closed. FIG. 6b shows an embodiment in which the light source 2 and the photodiode 4 (in the housing 5) are arranged in the basin 13. FIG. 6c shows an embodiment in which these are arranged outside the basin 13. The optical window(s) 7 is/are then part of the basin 13.

The relative distance between the measuring arrangement 1 and the medium surface 6 can be changed in order to “switch” between the measurement of the scattering in the medium, for example below 90°, and the measurement of the reflection at the surface. This can be effected by moving the measuring arrangement 1 towards the medium surface 6, in particular via a rotational or translational movement. Alternatively, the medium surface 6 can be lowered or raised. Examples are shown in the figures.

The light source 2 also transmits excitation light 8 into the medium towards the medium surface 6 (upwards), wherein the excitation light 8 is reflected at the medium surface 6. This reflected light (reference sign 9) is detected by the photodiode 4 and converted into an electrical signal.

As mentioned, the light source 2 and the photodiode 4 are connected to a data processing unit 10 (for example a microcontroller), which determines the measured variable to be determined, e.g. turbidity, from the electrical signal of the scattered and reflected light. The determination of this measured variable is effected by means of a calibration model, which combines the measured information on the received intensities and uses this to ascertain the turbidity. The reflected light is used to check the measurement with the scattered light or to resolve the ambiguity.

During detection of the reflection, the light source 2 transmits excitation light 8 substantially against gravity (even though gravity, of course, has no influence). “Below” within the meaning of this text is at the bottom of the medium, whereas “above” is at the surface. The light source 2 transmits excitation light 8 at a certain angle α from below against the medium surface 6. The reflected light 9 is received at an angle β. The light source 2 and the photodiode 4 are thus arranged below the medium surface 6. This is shown in FIG. 7.

If the angle α and/or the angle β are selected to be sufficiently small, the total reflection at the medium surface 6 leads to part or all of the excitation light being reflected, which increases the measured signal strength and if applicable will result in an easier distinction between the left-hand and right-hand sides of the curve of the scattered light signal, see FIG. 2b.

The reception of reflected light 9 may occur less frequently than the reception of scattered light 19. For this purpose, the measuring arrangement 1 is only occasionally moved, for example once per minute, per hour or per day, for checking the measured values in such a way that the signal is transmitted towards the medium surface 6. Alternatively, and as already mentioned above, the surface 6 (or the level) of the medium 3 can also be changed. The operation can also be started manually. Similarly, the “Transmit towards the surface 6” operation can be started if the turbidity value falls below or exceeds a certain threshold value (for example to avoid or resolve ambiguity).

In one embodiment of the measuring arrangement 1, the distance d from the light source 2 and the photodiode 4 to the medium surface 6 is variable (see above and FIGS. 6a-c). As a result, the “switching” between the measurement of scattering and reflection can be achieved. Likewise, the incidence angle α or the detection angle β can be variable. The angle β does not refer to the angle at which the turbidity is determined. The angle β is used to check whether the ascertained turbidity is plausible.

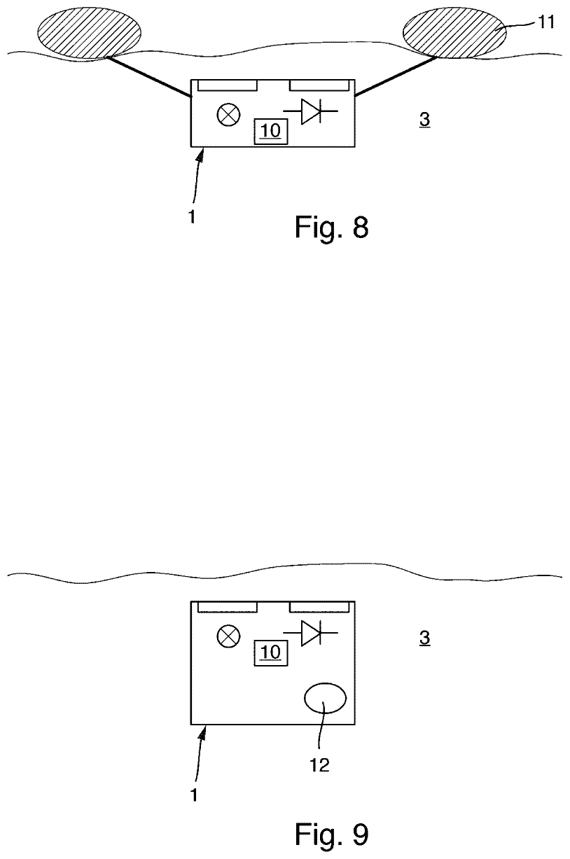

In FIGS. 8 and 9, only the differences from or additions to the previous figures are marked with reference signs. FIGS. 8 and 9 show embodiments for changing the distance from sensor 1 to surface 6.

FIG. 8 shows an embodiment with two floating bodies 11, which are arranged outside the measuring arrangement 1. It is possible to use just one. The floating body 11 is connected to the arrangement 1 via connecting pieces and holds it at a defined, but possibly variable, distance below the medium.

FIG. 9 shows an embodiment with a buoyancy chamber 12, which is arranged in the housing 5. This also holds the arrangement 1 at a defined (but possibly variable) distance below the medium surface 6. In one embodiment, the buoyancy chamber can be filled with air, water or the medium, so that the arrangement 1 can be moved.

In both cases, a continuous mobility of the measuring arrangement 1 relative to the surface 6 ensures that a depth profile of the turbidity can be ascertained.

In one embodiment, the measuring arrangement 1 is attached to a cord, rope, cable or the like, and can be manually or automatically raised and lowered in the medium 3 to change the distance to the medium surface 6.

1. A method for determining a scattered light parameter in a medium using a measuring arrangement, the method comprising:
transmitting excitation light into the medium, wherein the excitation light is scattered in the medium;
receiving the light scattered in the medium;
transmitting excitation light into the medium towards a medium surface, wherein the excitation light is reflected at the medium surface;
receiving the light reflected from the medium surface; and
determining the scattered light parameter from the light scattered in the medium and the light reflected at the medium surface.

2. The method according to claim 1, wherein a relative distance between the measuring arrangement and the medium surface is changed between the steps of receiving the light scattered in the medium and transmitting excitation light into the medium towards the medium surface.

3. The method according to claim 2, wherein the relative distance is changed by moving the measuring arrangement toward the medium surface.

4. The method according to claim 2, wherein the relative distance is changed by lowering or raising the medium surface.

5. The method according to claim 2, wherein an incidence angle of the excitation light into the medium is arranged such that total reflection occurs at the medium surface.

6. The method according to claim 1, wherein the steps of transmitting excitation light into the medium towards a medium surface and receiving the light reflected from the medium surface are performed less frequently than the steps of transmitting excitation light into a medium and receiving the light scattered in the medium.

7. A measuring arrangement for performing the method for determining a scattered light parameter in a medium according to claim 1, the measuring arrangement comprising:
at least one light source configured to transmit excitation light into the medium and toward the medium surface;
at least one photodiode configured to receive light scattered in the medium and light reflected at the medium surface and to convert the light scattered in the medium to an electrical signal; and
a data processing unit configured to determine the scattered light parameter from the electrical signal.

8. The measuring arrangement according to claim 7, comprising at least one floating body configured to hold the measuring arrangement at a defined but variable distance from the medium surface, wherein the at least one floating body is arranged outside the measuring arrangement.

9. The measuring arrangement according to claim 7, comprising at least one buoyancy chamber configured to hold the measuring arrangement at a defined but variable distance from the medium surface, wherein the buoyancy chamber is arranged in the measuring arrangement.

10. The measuring arrangement according to claim 7, comprising a basin with an inflow and an outflow for the medium, wherein the at least one light source and the at least one photodiode are arranged in the basin or outside the basin.

11. The measuring arrangement according to claim 7, comprising a basin with at least one inflow and a plurality of outflows for the medium, wherein the at least one light source and the at least one photodiode are arranged in the basin or outside the basin.

12. The method according to claim 1, wherein the scattered light parameter is turbidity, and the measuring arrangement includes a turbidity sensor.

13. The method according to claim 3, wherein the relative distance is changed by moving the measuring arrangement towards the medium surface via a rotational or translational movement.

14. The measuring arrangement of claim 7, wherein the scattered light parameter is turbidity.
